(19) United States
(12) Patent Application Publication
(10) Pub. No.: US 2012/0228268 A1
(43) Pub. Date: Sep. 13, 2012

(54) POWER SUPPLY DEVICE FOR ELECTRICAL DISCHARGE MACHINE AND CONTROL METHOD THEREFOR

(75) Inventors: Kazunari Morita, Chiyoda-ku (JP); Hiroki Hikosaka, Chiyoda-ku (JP)

(73) Assignee: MITSUBISHI ELECTRIC CORPORATION, Chiyoda-ku, Tokyo (JP)

(21) Appl. No.: 13/263,863

(22) PCT Filed: Feb. 25, 2011
(86) PCT No.: PCT/JP2011/054390

§ 371 Date: May 10, 2012

(51) Int. Cl. B23H 1/00

(52) U.S. Cl. 219/69.11

(57) ABSTRACT

The power supply device for electrical discharge machine is equipped with a capacitor that stores electric charge, a DC power supply V that charges the capacitor, a first switching element that generates a pulse-like discharge by applying the electric charge stored in the capacitor to an electrode gap, and a control unit that controls ON/OFF of the first switching element based on a voltage of the electrode gap. After controlling the first switching element to be ON so as to apply the electric charge stored in the capacitor to the electrode gap, the control unit changes an amount of time from a point when the voltage of the electrode gap is decreased to a predetermined value or lower to a point when the first switching element is controlled to be OFF, so as to control the magnitude of a discharge pulse generated in the electrode gap.

### FIELD

The present invention relates to a power supply device for an electrical discharge machine and a method for controlling a power supply device for an electrical discharge machine.

### BACKGROUND

In an electrical discharge machine, there are mainly two problems to be solved in a case where a control such that a discharge frequency is increased in order to enhance the machining ability thereof is performed. One is a charging time for a capacitor for storing electric charge that is to be discharge energy. The other is an amount of heat generation of a switching element which is controlled to be ON when discharging electric charge stored in the capacitor.

In order to solve the former problem of the above-described problems, the following Patent Literature 1 discloses, as a conventional power supply device for an electrical discharge machine, an embodiment in which four sets of a series circuit formed by a resistance and a capacitor are arranged in parallel to each other and the four capacitors are charged at different times so as to obtain the substantially four times longer charging time for the capacitors. Also, in order to solve the latter problem, there is disclosed an embodiment in which four switching elements are connected in parallel to each other and simultaneously turned ON to reduce an amount of heat generation for each switching element.

### CITATION LIST

### Patent Literature

Patent Literature 1: Japanese Patent Application Laid-open No. 2003-205426 (FIGS. 26 and 29)

### SUMMARY

### Technical Problem

However, since the technique shown in the above-described Patent Literature 1 is a technique in which the number of discharging circuits and charging circuits arranged parallel to each other is simply increased, there has been a problem that an increase in the circuit size is unavoidable in order to enhance the machining ability.

The present invention has been made in view of the above, and an object of the present invention is to provide a power supply device for an electrical discharge machine capable of avoiding or suppressing an increase in the circuit size when enhancing the machining ability thereof, and a method for controlling the same.

### Solution to Problem

In order to solve the aforementioned problems, a power supply device for an electrical discharge machine according to one aspect of the present invention is constructed in such a manner as to include: a charge storing element that stores electric charge; a DC power supply that charges the charge storing element; a first switching element that generates a pulse-like discharge by applying the electric charge stored in the charge storing element to an electrode gap; and a control unit having a detecting unit that detects various electrical quantities, which wary in accordance with a voltage of the electrode gap or a voltage applied to the electrode gap, for controlling ON and OFF of the first switching element based on a detected value of the various electrical quantities detected by the detecting unit, wherein after controlling the first switching element to be ON so as to apply the electric charge stored in the charge storing element to the electrode gap, the control unit changes an amount of time from a point when the detected value of the various electrical quantities is decreased to a predetermined value or lower to a point when the first switching element is controlled to be OFF, thereby to control a magnitude of a discharge pulse generated in the electrode gap.

### Advantageous Effects of Invention

According to the present invention, such an effect is obtained that an increase in the circuit size can be avoided or suppressed when enhancing the machining ability.

### BRIEF DESCRIPTION OF DRAWINGS

FIG. 1 is a diagram showing a configuration example of an electrical discharge machine including a power supply device for an electrical discharge machine according to a first embodiment.

FIG. 2 is a diagram showing an example of a timing chart in a case where a relatively small pulse discharge of an electrode gap current is generated.

FIG. 3 is a diagram showing an example of a timing chart in a case where a relatively large pulse discharge of an electrode gap current is generated.

FIG. 4 is a diagram showing an example of a timing chart in a case where a group pulse discharge in which a large pulse discharge and a small pulse discharge of an electrode gap current are mixed is generated.

FIG. 5 is a diagram showing a configuration example of an electrical discharge machine including a power supply device for an electrical discharge machine according to a second embodiment.

FIG. 6 is a diagram showing an example of a timing chart according to a control operation of the second embodiment.

FIG. 7 is a diagram showing a configuration example of an electrical discharge machine including a power supply device for an electrical discharge machine according to a third embodiment.

FIG. 8 is a diagram showing a configuration example of an electrical discharge machine including a power supply device for an electrical discharge machine according to a fourth embodiment.

FIG. 9 is a diagram showing a configuration example of an electrical discharge machine including a power supply device for an electrical discharge machine according to a fifth embodiment.

### DESCRIPTION OF EMBODIMENTS

A power supply device for an electrical discharge machine and a method for controlling the same according to embodiments of the present invention will be described below with reference to the accompanying drawings. Note that the present invention is not limited to the embodiments to be described below.

### First Embodiment

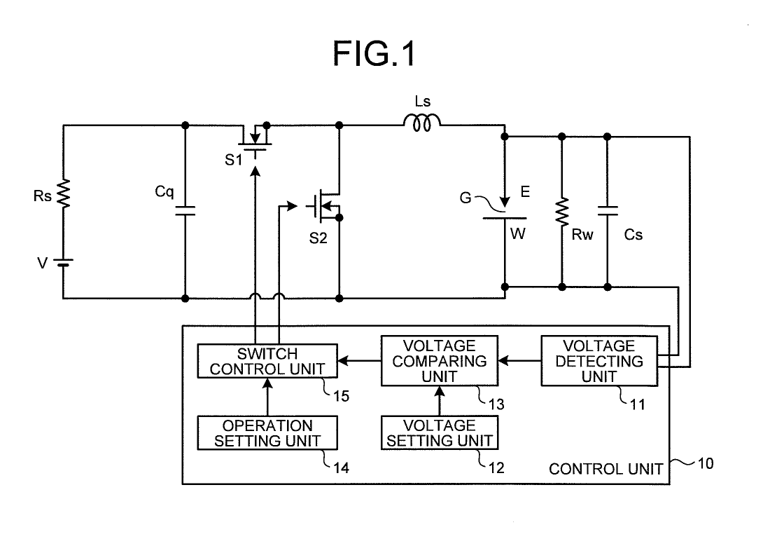

FIG. 1 is a diagram showing a configuration example of an electrical discharge machine including a power supply device for an electrical discharge machine according to the first embodiment. The power supply device for an electrical discharge machine according to the first embodiment is configured to include a DC power supply V, a resistance Rs, a capacitor Cq, a first switching element S1, a second switching element S2, and a control unit 10.

In FIG. 1, a workpiece W and an electrode E (a wire in a case of a wire electrical discharge machine, or a mold electrode in a case of a die sinking electrical discharge machine) are connected to the DC power supply V via the first switching element S1 (herein, an FIT is illustrated as an example) and the resistance Rs. The capacitor Cq is a charge storing element and connected to both ends of the series-connected resistance Rs and DC power supply V. A drain end of the first switching element S1 is connected to one end of the capacitor Cq, and a source end thereof is connected to a drain end of the second switching element S2 (herein, an FET is illustrated as an example). A source end of the second switching element S2 is connected to the other end of the capacitor Cq, thereby resulting in a circuit configuration such that the source end of the second switching element S2 is connected to a negative terminal of the DC power supply V.

In view of the circuit configuration, a capacitance Cs and a resistance Rw of a machining fluid are added to both ends of the workpiece W and the electrode E so as to be parallel-connected with each other. In addition to these capacitance Cs and resistance Rw, a parasitic inductance Ls possibly present in a current path between the DC power supply V and the electrode E is added to form an electric circuit. Note that the parasitic inductance Ls is an inductance component present inside the power supply device for an electrical discharge machine, or an inductance component possessed by a conductor portion connecting the power supply device for an electrical discharge machine with the workpiece W and the electrode E.

On the other hand, the control unit 10 is a constituent unit for performing a switching control of the first switching element S1 and the second switching element S2. The control unit 10 is configured to include a voltage detecting unit 11, a voltage setting unit 12, a voltage comparing unit 13, an operation setting unit 14, and a switch control unit 15. The voltage detecting unit 11 detects a voltage generated in an electrode gap G formed between the workpiece W and the electrode E (hereinafter, referred to as an “electrode gap voltage”). The voltage comparing unit 13 compares the electrode gap voltage detected by the voltage detecting unit 11 with a set voltage from the voltage setting unit 12, generates a comparison signal indicating whether or not the electrode gap voltage is higher than the set voltage, and inputs the comparison signal to the switch control unit 15. The switch control unit 15 controls the first switching element S1 and the second switching element S2 by generating control signals that turns ON or OFF the first switching element S1 and the second switching element S2 based on the comparison signal from the voltage comparing unit 13 and a signal set in the operation setting unit 14.

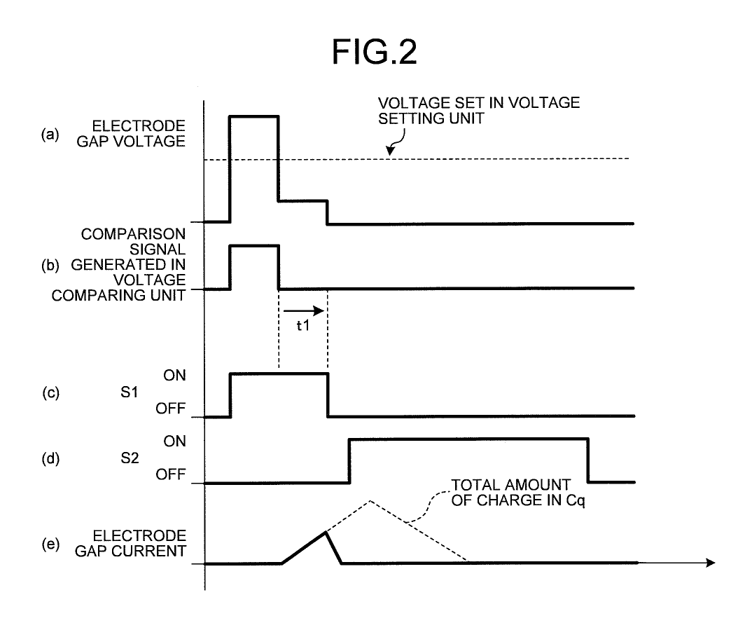

Next, an operation of the power supply device for an electrical discharge machine will be described. FIG. 2 is a diagram showing an example of a timing chart in a case where a relatively small pulse discharge of an electrode gap current is generated. In FIG. 2, the switch control unit 15 controls the first switching element S1 to be ON. Then, the electric charge stored in the capacitor Cq is applied to the electrode gap G, thereby increasing an electrode gap voltage. The electrode gap voltage is detected by the voltage detecting unit 11. If the electrode gap voltage is greater than the voltage set at the voltage setting unit 12 (hereinafter, referred to as a “set voltage”) (FIG. 2(a)), a comparison signal is generated at the voltage comparing unit 13 (FIG. 2(b)). When a discharge is started and an electrode gap current is started to flow after a rise in the electrode gap voltage, the electrode gap voltage is decreased (FIG. 2(a)). The switch control unit 15 controls the first switching element S1 to be OFF after a passage of a predetermined amount of time t1 since the fall of the comparison signal (FIG. 2(c)). After controlling the first switching element S1 to be OFF, the switch control unit 15 controls the second switching element S2 to be ON at a timing such that the first switching element S1 and the second switching element 52 are not being ON simultaneously (FIG. 2(d)). Due to this control, the second switching element S2 causes short circuit between the workpiece W and the electrode E (electrode gap), and the electric charge remained in the capacitance Cs in the electrode gap is discharged. Note that since the first switching element S1 is OFF, the electric charge remained in the capacitor Cq is maintained.

With the above-described control, an electrode gap current as shown in FIG. 2(e) flows. Note that a broken line in FIG. 2(e) is an imaginary line representing the magnitude of a current expected to flow when a discharge is made by using the total amount of electric charge stored in the capacitor Cq, and an area of a region surrounded by the broken line and the temporal axis corresponds to the total amount of electric charge stored in the capacitor Cg. In a case of FIG. 2, since the predetermined amount of time t1 for controlling the first switching element S1 to be OFF after the fall of the comparison signal is set to be small, it is possible to limit the magnitude of the electrode gap current to a relatively small value.

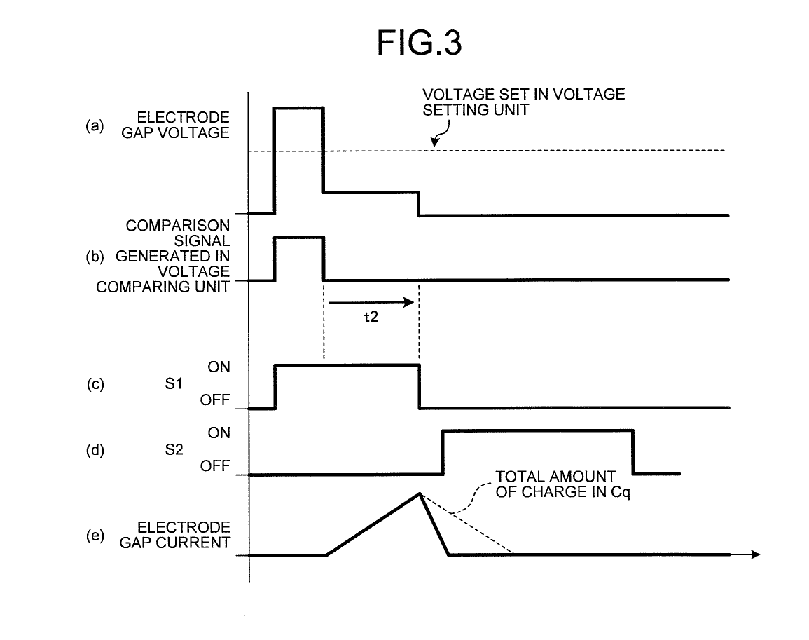

On the other hand, FIG. 3 is a diagram showing an example of a timing chart in a case where a relatively large pulse discharge of an electrode gap current is generated. FIG. 3 differs from FIG. 2 regarding control in that a predetermined amount of time t2 for controlling the first switching element S1 to be OFF after the fall of a comparison signal is set to be longer than the case of FIG. 2 (the predetermined amount of time t1) (t2>t1) as shown in FIG. 3(c). The electric charge stored in the capacitor Cq is supplied to the electrode gap G in accordance with a time constant substantially determined by the parasitic inductance Ls and the capacitance Cs during the ON period of the first switching element S1. In a case of FIG. 3, since the amount of time during which the electric charge is supplied to the electrode gap G is greater than that in the example of FIG. 2, the peak value of the electrode gap current becomes greater and the amount of time during which the electrode gap current flows also becomes greater. Note that while the predetermined amount of time t2 for controlling the first switching element S1 to be OFF exists in the vicinity of the peak of the electrode gap current as shown in FIG. 3(e) in the example of FIG. 3, it is not limited to the vicinity of the peak of the electrode gap current. For example, the predetermined amount of time t2 for controlling the first switching element S1 to be OFF may be a large amount of time exceeding the peak of the electrode gap current.

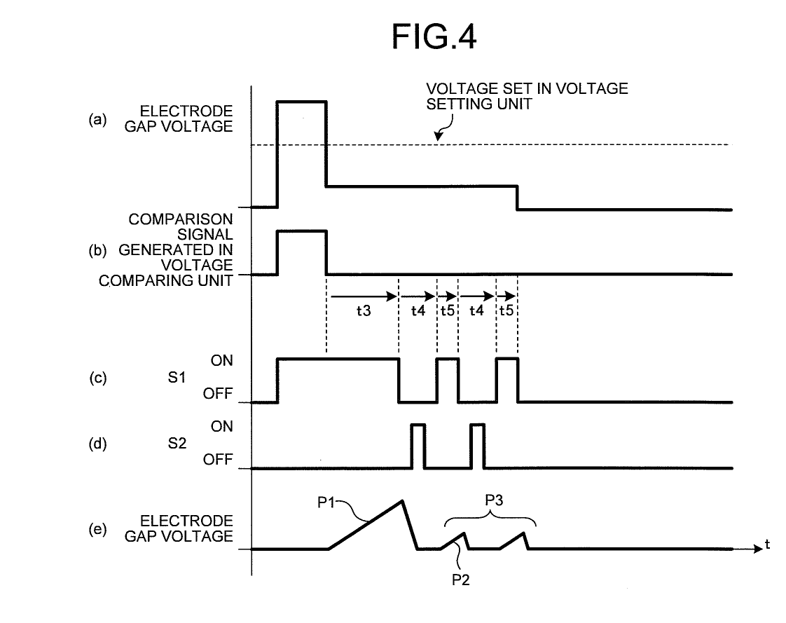

FIG. 4 is a diagram showing an example of a timing chart in a case where a group pulse discharge with a pulse discharge having a large amount of electric charge and a pulse discharge having a small amount of electric charge mixed therein is generated. In the present example, as shown in FIG. 4(e), a control is made so that following a current pulse (P1) having a large electrode gap current, there is generated a group pulse (P2) such that a current pulse having a small electrode gap current successively occurs.

With an electrical discharge machine, when machining is performed with a goal of obtaining a certain shape, it is rare to complete the work with only one-time machining. In general, it is necessary to perform machining about several times from a machining called rough machining to a machining called finish machining for increasing the surface accuracy of the cut surface of the workpiece. Therefore, in a general electrical discharge machine, in order to cover a range from rough machining using a large energy to finish machining using a small energy, a control in such a manner that the settings of the power supply are switched therebetween to change the magnitude of a discharge pulse in accordance with the machining is performed, or that a plurality of power circuits are provided so as to switch the power circuits themselves. Moreover, in order to simultaneously achieve a high machining speed and a fine surface roughness, it is also practiced that among successively-occurred pulse discharges, one large discharge pulse and a plurality of small discharge pulses are repeatedly applied.

Also in the electrical discharge machine of the first embodiment, it is preferable to have a function to control the magnitude of a discharge pulse in accordance with rough machining and finish machining and a function to be able to repeatedly apply, among successively-occurred pulse discharges, one large discharge pulse and a plurality of small discharge pulses as described above. The electrical discharge machine of the first embodiment realizes these functions by the function of the control unit 10.

Returning to FIG. 4, the operations shown in FIGS. 4(a) and 4(b) are similar to those of FIG. 2 and FIG. 3. On the other hand, in the example shown in FIG. 4, a large discharge pulse (P1) of the electrode gap current is first generated by controlling the first switching element S1 to be OFF after the passage of a predetermined amount of time t3 (the first predetermined amount of time) since the fall of the comparison signal. Thereafter, the first switching element S1 is controlled to be ON after the passage of a predetermined amount of time t4 (the second predetermined amount of time) since the point when the first switching element S1 is controlled to be OFF, and the first switching element S1 is controlled to be OFF after the passage of a predetermined amount of time t5 (the third predetermined amount of time) since the point when the first switching element S1 is controlled to be ON. As a result, a small discharge pulse (P2) of the electrode gap current is generated. Furthermore, a small pulse group (P3) of the electrode gap current, together with the above-described discharge pulse P2, is generated by repeating the control of the OFF period t4 and the ON period t5 for a predetermined number of times.

Note that while the second switching element S2 is controlled to be ON in the period of t4 during which the first switching element S1 is controlled to be OFF in the example of FIG. 4 (FIG. 4(d)), such a control is a control for discharging electric charge remained in the capacitance Cs. Additionally, while the control such that the OFF period t4 and the ON period t5 are repeated is performed in the example of FIG. 4, these time parameters are not required to be the same, and pulse widths before and after the group pulse can be obviously changed.

As described above, with the power supply device for an electrical discharge machine and the method for controlling the same according to the first embodiment, the control unit 10 controls the first switching element S1 to be ON so as to apply the electric charge stored in the capacitor Cq to the electrode gap G, and then changes the amount of time from a point when the detected voltage detected by the voltage detecting unit 11 is decreased to the predetermined value or lower to a point when the first switching element S1 is controlled to be OFF, thereby controlling the magnitude of the discharge pulse to be generated in the electrode gap G. Thus, it is possible to enhance the machining ability without modifying the circuit configuration of the power supply device for an electrical discharge machine.

Moreover, according to the power supply device for an electrical discharge machine and the method for controlling the same according to the first embodiment, since it is possible to arbitrarily control the amount of time from a point when the first switching element S1 is turned ON to a point when the first switching element S1 is turned OFF, it becomes possible to generate a plurality of discharge pulses having different current values while avoiding or suppressing an increase in the circuit size.

Furthermore, according to the power supply device for an electrical discharge machine and the method for controlling the same according to the first embodiment, since discharge pulses having different current values can be generated by suitably controlling the amount of time from a point when the first switching element S1 is turned ON to a point when the first switching element S1 is turned OFF, it becomes possible to maintain a certain machining condition even when an electrode gap impedance is changed due to a change in the workpiece W or the environment.

Note that a switching element whose material is silicon (Si) (IGBT, MOSFET, or the like) is typically used as a switching element used in a conventional power supply device for an electrical discharge machine. On the other hand, the technique described in the first embodiment above is not limited to the switching element formed by using silicon as a material. Instead of silicon, a switching element whose material is silicon carbide (SiC), which has been attracting attention in recent years, can be of course used for the power supply device for an electrical discharge machine.

Here, since silicon carbide has a characteristic such that it can be used at a high temperature, an allowable operation temperature for a switching element can be increased by using the switching element whose material is silicon carbide as the switching element included in the power supply device for an electrical discharge machine. Therefore, it becomes possible to reliably avoid the problem of an amount of heat generation. This makes it possible to enhance the machining ability while avoiding or suppressing an increase in the circuit size.

Further, the switching element formed by silicon carbide has a high heat resistance. Therefore, it becomes possible to reduce the size of a radiator (heat sink) added to the switching element, and thus to further reduce the size of the device.

Furthermore, since the switching element formed by silicon carbide has a low level of power loss, it is possible to realize a highly efficient switching element, and thus to realize a highly efficient device.

Note that silicon carbide (SiC) is an example of a semiconductor called a wide bandgap semiconductor, viewing such a characteristic that silicon carbide has a wider bandgap than silicon (Si). Apart from silicon carbide, a semiconductor formed by using, for example, a gallium nitride material or diamond also belongs to a wide bandgap semiconductor, and characteristics of these semiconductors have many similarities to those of silicon carbide. Therefore, a configuration using another wide bandgap semiconductor other than silicon carbide also falls within the scope of the present invention.

### Second Embodiment

FIG. 5 is a diagram showing a configuration example of an electrical discharge machine including a power supply device for an electrical discharge machine according to a second embodiment. FIG. 5 differs from FIG. 1 in that while a floating capacitance Cp, resistance Rp, and inductance Lp resulting from another electric circuit or the mechanical structure are added to respective ends of the workpiece W and the electrode E, the second switching element S2 is omitted. Especially in a case of a die sinking electrical discharge machine, the circuit configuration of FIG. 5 can be realized. Even with those other than the die sinking electrical discharge machine, in a case where a floating resistance component resulting from another electric circuit or the mechanical structure exists and the resistance value has such a magnitude as to enable a discharge operation to be described later, the second switching element S2 can be omitted.

In FIG. 5, the floating resistance Rp is smaller than the resistance Rw of the machining fluid. Thus, even when no discharge occurs or even when a discharge occurs, but the discharge is a small discharge of the electrode gap current, the electric charge stored in the capacitances Cs and Cp is discharged through the resistance Rp. Therefore, the electric charge remained in the electrode gap G can disappear.

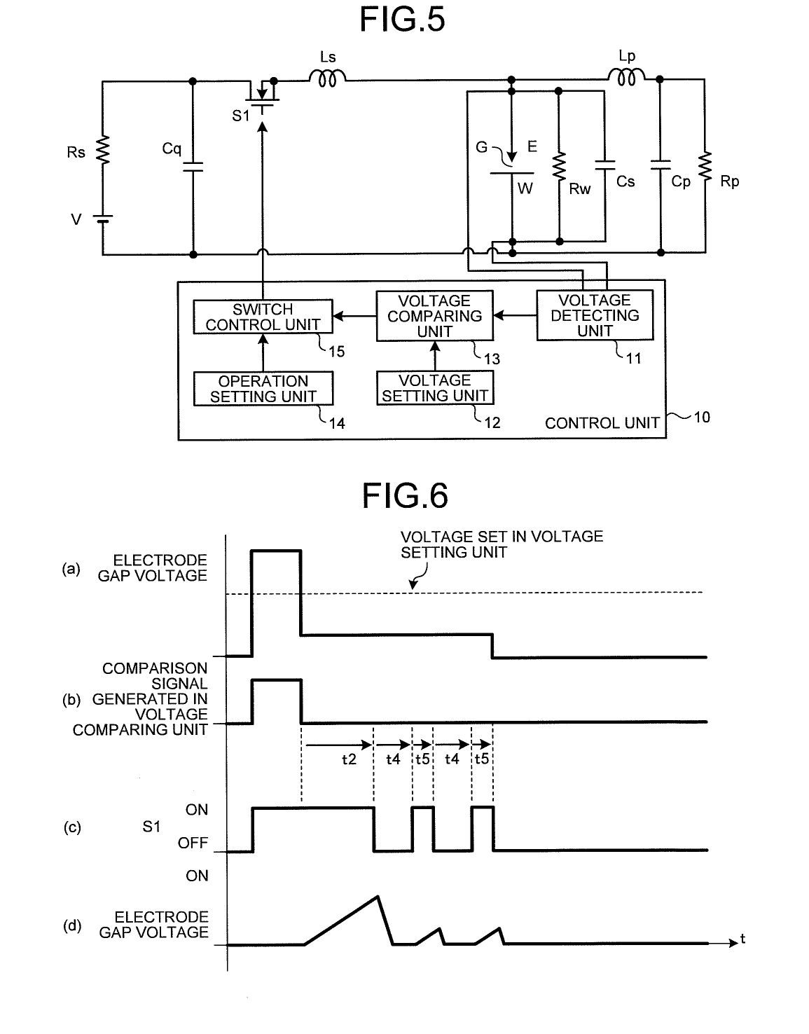

FIG. 6 is a diagram showing an example of a timing chart according to a control operation of the second embodiment. FIG. 6 differs from FIG. 4 only in that there exists no control regarding the second switching element. The other operations of FIG. 6 are identical to those of FIG. 4. Thus, the power supply device for an electrical discharge machine and the method for controlling the same according to the second embodiment can also attain the effects identical or equivalent to those of the first embodiment.

### Third Embodiment

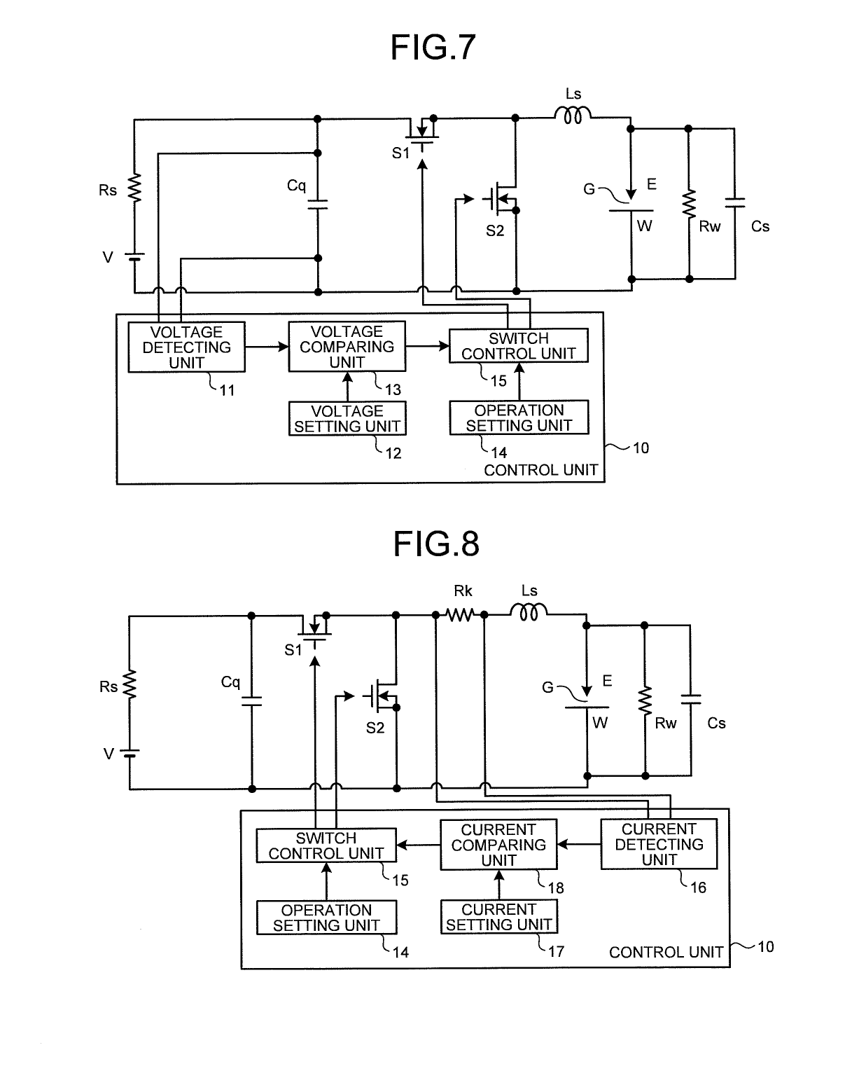

FIG. 7 is a diagram showing a configuration example of an electrical discharge machine including a power supply device for an electrical discharge machine according to a third embodiment. FIG. 7 differs from FIG. 1 only in that detecting portions of the voltage detecting unit 11 are changed to both ends of the capacitor Cq from the electrode gap (between the workpiece W and the electrode E).

The voltage of the capacitor Cq is one of various electrical quantities directly representing the amount of electric charge stored in the capacitor Cq, and a change in the voltage of the capacitor Cq involved in a discharge takes a behavior similar to a change in the voltage of the electrode gap G. Thus, the power supply device for an electrical discharge machine and the method for controlling the same according to the third embodiment can also attain the effects identical or equivalent to those of the first or the second embodiment.

### Fourth Embodiment

FIG. 8 is a diagram showing a configuration example of an electrical discharge machine including a power supply device for an electrical discharge machine according to a fourth embodiment. The fourth embodiment differs from the first embodiment in that while the detection target of the control unit 10 is a voltage in the electrode gap G in the first embodiment, the detection target of the control unit 10 is a current flowing through the electrode gap G in the fourth embodiment. Thus, in the fourth embodiment, the control unit 10 includes a current detecting unit 16 instead of the voltage detecting unit 11, a current setting unit 17 instead of the voltage setting unit 12, and a current comparing unit 18 instead of the voltage comparing unit 13. The control unit 10 is also provided with a shunt resistance Rk for current detection on a current path between the first switching element S1 and the electrode gap G. Note that the other configurations are identical or equivalent to those of FIG. 1, and the identical elements are denoted by like reference letters or numerals.

Next, operations of the power supply device for an electrical discharge machine will be described. The current detecting unit 16 detects a current flowed through the electrode gap C for machining (hereinafter, referred to as a “machining current”) as a voltage occurring at both ends of the shunt resistance Rk. The current comparing unit 18 compares the machining current detected by the current detecting unit 16 with a set current from the current setting unit 17 to generate a comparison signal indicating whether or not the machining current is higher than the set current. The current comparing unit 18 then inputs the comparison signal to the switch control unit 15. The switch control unit 15 controls the first switching element S1 and the second switching element S2 by generating control signals for turning ON or OFF the first switching element S1 and the second switching element S2 based on the comparison signal from the current comparing unit 18 and the signal set in the operation setting unit 14. Note that the following operations are identical or equivalent to those of the first embodiment.

The electrode gap current is one of various electrical quantities directly representing the discharge energy, and a change in the machining current involved by a discharge takes a behavior similar to a change in the voltage of the electrode gap G. Thus, the power supply device for an electrical discharge machine and the method for controlling the same according to the fourth embodiment can also attain the effects identical or equivalent to those of the first to the third embodiments.

### Fifth Embodiment

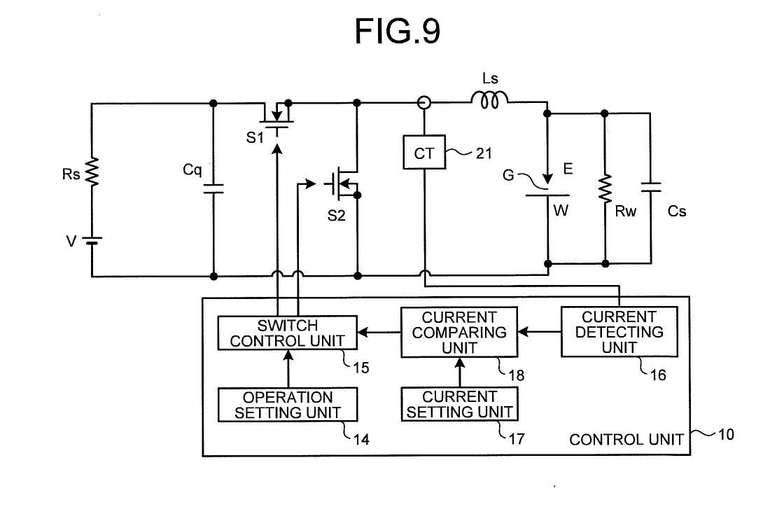

FIG. 9 is a diagram showing a configuration example of an electrical discharge machine including a power supply device for an electrical discharge machine according to a fifth embodiment. FIG. 9 differs from FIG. 8 only in that detection means for the machining current is changed from the shunt resistance Rk to a current transformer (CT) 21. Thus, the power supply device for an electrical discharge machine and the method for controlling the same according to the fifth embodiment can also attain the effects identical or equivalent to those of the first to the fourth embodiments.

Note that when the current transformer 21 is used, there is no need to insert the shunt resistance Rk. Therefore, it is possible to reduce the power consumption of the device as compared to the power supply device for an electrical discharge machine of the fourth embodiment since there exists no loss by the shunt resistance Rk.

Although the power supply devices for an electrical discharge machine and the methods for controlling the same according to the first to the fifth embodiments have been described above, it is to be understood that each of the above-described configurations is merely an example of the configuration of the present invention and may be combined with another known technique. It will be appreciated that the above-described configuration is susceptible of change, e.g., omitting a part thereof, without departing from the scope of the present invention.

### INDUSTRIAL APPLICABILITY

As described above, the power supply devices for an electrical discharge machine and the methods for controlling a power supply device for an electrical discharge machine according to the embodiments are useful as inventions for enhancing the machining ability while avoiding or suppressing an increase in the circuit size.

### REFERENCE SIGNS LIST

10 CONTROL UNIT
11 VOLTAGE DETECTING UNIT
12 VOLTAGE SETTING UNIT
13 VOLTAGE COMPARING UNIT
14 OPERATION SETTING UNIT
15 SWITCH CONTROL UNIT
16 CURRENT DETECTING UNIT
17 CURRENT SETTING UNIT
18 CURRENT COMPARING UNIT
21 CURRENT TRANSFORMER (CT)
Cp, Cs CAPACITANCE
Cq CAPACITOR
E ELECTRODE
G ELECTRODE GAP
Lp INDUCTANCE
Ls PARASITIC INDUCTANCE
Rk SHUNT RESISTANCE
Rp, Rs RESISTANCE
Rw RESISTANCE OF MACHINING FLUID
S1 FIRST SWITCHING ELEMENT
S2 SECOND SWITCHING ELEMENT
V DC POWER SUPPLY
W WORKPIECE

1. A power supply device for an electrical discharge machine, comprising:
a charge storing element that stores electric charge;
a DC power supply that charges the charge storing element;
a first switching element that generates a pulse-like discharge by applying the electric charge stored in the charge storing element to an electrode gap; and
a control unit having a detecting unit that detects various electrical quantities, which wary in accordance with a voltage of the electrode gap or a voltage applied to the electrode gap, for controlling ON and OFF of the first switching element based on a detected value of the various electrical quantities detected by the detecting unit, wherein
after controlling the first switching element to be ON so as to apply the electric charge stored in the charge storing element to the electrode gap, the control unit changes an amount of time from a point when the detected value of the various electrical quantities is decreased to a predetermined value or lower to a point when the first switching element is controlled to be OFF, thereby controlling a magnitude of a discharge pulse generated in the electrode gap.

2. The power supply device for an electrical discharge machine according to claim 1, wherein the control unit controls the first switching element to be OFF after a passage of a first predetermined amount of time since the point when the detected value of the various electrical quantities is decreased to the predetermined value or lower, thereby generating a first discharge pulse in the electrode gap; and the control unit controls the first switching element to be ON after a passage of a second predetermined amount of time since a point when the first switching element is controlled to be OFF and controls the first switching element to be OFF after a passage of a third predetermined amount of time, which is shorter than the first predetermined amount of time, since a point when the first switching element is controlled to be ON, thereby generating a second discharge pulse, which is smaller than the first discharge pulse, in the electrode gap.

3. The power supply device for an electrical discharge machine according to claim 2, wherein the second discharge pulse is composed of a plurality of discharge pulses.

4. The power supply device for an electrical discharge machine according to claim 1, further comprising a second switching element that is parallel-connected to the electrode gap and configured to be able to shunt the electrode gap, and wherein
the control unit controls the second switching element during an OFF period of the first switching element to discharge electric charge stored in the electrode gap.

5. The power supply device for an electrical discharge machine according to claim 1, wherein the first switching element is formed by a wide bandgap semiconductor.

6. The power supply device for an electrical discharge machine according to claim 5, wherein the wide bandgap semiconductor is a semiconductor using at least one of silicon carbide, a gallium nitride material, and diamond.

7. The power supply device for an electrical discharge machine according to claim 1, wherein the detecting unit that detects the various electrical quantities is a voltage detecting unit, and the voltage detecting unit detects the voltage of the electrode gap.

8. The power supply device for an electrical discharge machine according to claim 1, wherein the detecting unit that detects the various electrical quantities is a voltage detecting unit, and the voltage detecting unit detects a voltage of the electric charge storing element.

9. The power supply device for an electrical discharge machine according to claim 1, wherein the detecting unit that detects the various electrical quantities is a current detecting unit, and the current detecting unit detects a current flowing through the electrode gap.

10. A method for controlling a power supply device for an electrical discharge machine, the power supplying device including a charge storing element that stores electric charge, a DC power supply that charges the charge storing element, a first switching element that generates a pulse-like discharge by applying the electric charge stored in the charge storing element to an electrode gap, and a detecting unit that detects various electrical quantities which wary in accordance with a voltage of the electrode gap or a voltage applied to the electrode gap, the method comprising:
a first step of controlling the first switching element to be ON so as to apply the electric charge stored in the charge storing element to the electrode gap; and
a second step of changing, after the control by the first step, an amount of time from a point when a detected value of the various electrical quantities is decreased to a predetermined value or lower to a point when the first switching element is controlled to be OFF, thereby controlling a magnitude of a discharge pulse generated in the electrode gap.

11. The method for controlling a power supply device for an electrical discharge machine according to claim 10, wherein
the power supply device for an electrical discharge machine is provided with a second switching element that is parallel-connected to the electrode gap and configured to be able to shunt the electrode gap, and
in an OFF period of the first switching element after the second step, the method comprises a third step of controlling the second switching element to discharge the electric charge stored in the electrode gap.

12. The method for controlling a power supply device for an electrical discharge machine according to claim 10, wherein the second step comprises:
a first sub-step of controlling the first switching element to be OFF after a passage of a first predetermined amount of time since the point when the detected value of the various electrical quantities is decreased to the predetermined value or lower;
a second sub-step of controlling the first switching element to be ON after a passage of a second predetermined amount of time since a point when the first switching element is controlled to be OFF by the first sub-step; and
a third sub-step of controlling the first switching element to be OFF after a passage of a third predetermined amount of time, which is shorter than the first predetermined amount of time, since a point when the first switching element is controlled to be ON by the second sub-step.

13. The method for controlling a power supply device for an electrical discharge machine according to claim 12, wherein
the power supply device for an electrical discharge machine is provided with a second switching element that is parallel-connected to the electrode gap and configured to be able to shunt the electrode gap, and
at least in one of an OFF period of the first switching element after the first sub-step and an OFF period of the first switching element after the third sub-step, a sub-step of controlling the second switching element to discharge the electric charge stored in the electrode gap is included.
